(19) United States
(12) Patent Application Publication
(10) Pub. No.: US 2013/0167055 A1
(43) Pub. Date: Jun. 27, 2013

(54) METHOD, APPARATUS AND SYSTEM FOR SELECTING A USER INTERFACE OBJECT

(71) Applicant: CANON KABUSHIKI KAISHA, Tokyo (JP)

(72) Inventors: Alex PENEV, New South Wales (AU); Nicholas Grant FULTON, New South Wales (AU)

(73) Assignee: CANON KABUSHIKI KAISHA, Tokyo (JP)

(21) Appl. No.: 13/720,576

(22) Filed: Dec. 19, 2012

(30) Foreign Application Priority Data
Dec. 21, 2011 (AU) 2011265428

(51) Int. Cl. G06F 3/0482

(52) U.S. Cl. CPC G06F 3/0482
USPC 715/765; 715/810

(57) ABSTRACT

A method of selecting at least one user interface (UI) object from a plurality of UI objects, is disclosed. Each UI object represents an image and is associated with metadata values. A set of the UI objects is displayed on the display screen (114A), at least some of which is at least partially overlapping. The method detects a user pointer motion gesture, defining a magnitude value, on the multi-touch device in relation to the display screen (114A). In response to the motion gesture, at least some UI objects are moved in a first direction to reduce the overlap. The movement of each UI object is based on the magnitude value, the metadata values associated with that UI object, and on at least one metadata attribute. A subset of the UI objects may be moved in response to the motion gesture is selected.

### CROSS-REFERENCE TO RELATED PATENT APPLICATIONS

This application claims the right of priority under 35 U.S.C. §119 based on Australian Patent Application No. 2011265428, filed 21 Dec. 2011, which is incorporated by reference herein in its entirety as if fully set forth herein.

### FIELD OF INVENTION

The present invention relates to user interfaces and, in particular, to digital photo management applications. The present invention also relates to a method, apparatus and system for selecting a user interface object. The present invention also relates to computer readable medium having a computer program recorded thereon for selecting a user interface object.

### DESCRIPTION OF BACKGROUND ART

Digital cameras use one or more sensors to capture light from a scene and record the captured light as a digital image file. Such digital camera devices enjoy widespread use today. The portability, convenience and minimal cost-of-capture of digital cameras have contributed to users capturing and storing very large personal image collections. It is becoming increasingly important to provide users with image management tools to assist them with organizing, searching, browsing, navigating, annotating, editing, sharing, and storing their collection.

In the past, users have been able to store their image collections on one or more personal computers using the desktop metaphor of a file and folder hierarchy, available in most operating systems. Such a storage strategy is simple and accessible, requiring no additional software. However, individual images become more difficult to locate or rediscover as a collection grows.

Alternatively, image management software applications may be used to manage large collections of images. Examples of such software applications include Picasa™ by Google Inc., iPhoto™ by Apple Inc., ACDSee™ by ACD Systems International Inc., and Photoshop Elements™ by Adobe Systems Inc. Such software applications are able to locate images on a computer and automatically index folders, analyse metadata, detect objects and people in images, extract geo-location, and more. Advanced features of image management software applications allow users to find images more effectively.

Web-based image management services may also be used to manage large collections of images. Examples of image management services include Picasa Web Albums™ by Google Inc., Flickr™ by Yahoo! Inc., and Facebook™ by Facebook Inc. Typically such web services allow a user to manually create online photo albums and upload desired images from their collection. One advantage of using Web-based image management services is that the upload step forces the user to consider how they should organise their images in web albums. Additionally, the web-based image management services often encourage the user to annotate their images with keyword tags, facilitating simpler retrieval in the future.

In the context of search, the aforementioned software applications—both desktop and online versions—cover six prominent retrieval strategies as follows: (1) using direct navigation to locate a folder known to contain target images; (2) use keyword tags to match against extracted metadata; (3) using a virtual map to specify a geographic area of interest where images were captured; (4) using a color wheel to specify the average colour of the target images; (5) using date ranges to retrieve images captured or modified during a certain time; (6) specifying a particular object in the image, such as a person or a theme, that some image processing algorithm may have discovered. Such search strategies have different success rates depending on the task at hand.

Interfaces for obtaining user input needed to execute the above search strategies are substantially different. For example, an interface may comprise a folder tree, a text box, a virtual map marker, a colour wheel, a numeric list, and an object list.

Some input methods are less intuitive to use than others and, in particular, are inflexible in their feedback for correcting a failed query. For example, if a user believes an old image was tagged with the keyword ‘Christmas’ but a search for the keyword fails to find the image, then the user may feel at a loss regarding what other query to try. It is therefore of great importance to provide users with interfaces and search mechanisms that are user-friendly, more tolerant to error, and require minimal typing and query reformulating.

### SUMMARY OF THE INVENTION

It is an object of the present invention to substantially overcome, or at least ameliorate, one or more disadvantages of existing arrangements.

According to one aspect of the present disclosure there is provided a method of selecting at least one user interface object, displayed on a display screen of a multi-touch device, from a plurality of user interface objects, said method comprising:

determining a plurality of user interface objects, each said object representing an image and being associated with metadata values;

displaying a set of the user interface objects on the display screen, one or more of said displayed user interface objects at least partially overlapping;

detecting a user pointer motion gesture on the multi-touch device in relation to the display screen, said user pointer motion gesture defining a magnitude value;

moving, in response to said motion gesture, one or more of the displayed user interface objects to reduce the overlap between the user interface objects in a first direction, wherein the movement of each user interface object is based on the magnitude value, the metadata values associated with that user interface object, and on at least one metadata attribute; and

selecting a subset of the displayed user interface objects which moved in response to the motion gesture.

According to another aspect of the present disclosure there is provided an apparatus for selecting at least one user interface object, displayed on a display screen of a multi-touch device, from a plurality of user interface objects, said apparatus comprising:

means for determining a plurality of user interface objects, each said object representing an image and being associated with metadata values;

means for displaying a set of the user interface objects on the display screen, one or more of said displayed user interface objects at least partially overlapping;

means for detecting a user pointer motion gesture on the multi-touch device in relation to the display screen, said user pointer motion gesture defining a magnitude value;

means for moving, in response to said motion gesture, one or more of the displayed user interface objects to reduce the overlap between the user interface objects in a first direction, wherein the movement of each user interface object is based on the magnitude value, the metadata values associated with that user interface object, and on at least one metadata attribute; and

means for selecting a subset of the displayed user interface objects which moved in response to the motion gesture.

According to still another aspect of the present disclosure there is provided a system for selecting at least one user interface object, displayed on a display screen of a multi-touch device, from a plurality of user interface objects, said system comprising:

a memory for storing data and a computer program;

a processor coupled to said memory for executing said computer program, said computer program comprising instructions for:
determining a plurality of user interface objects, each said object representing an image and being associated with metadata values;
displaying a set of the user interface objects on the display screen, one or more of said displayed user interface objects at least partially overlapping;
detecting a user pointer motion gesture on the multi-touch device in relation to the display screen, said user pointer motion gesture defining a magnitude value;
moving, in response to said motion gesture, one or more of the displayed user interface objects to reduce the overlap between the user interface objects in a first direction, wherein the movement of each user interface object is based on the magnitude value, the metadata values associated with that user interface object, and on at least one metadata attribute; and
selecting a subset of the displayed user interface objects which moved in response to the motion gesture.

According to still another aspect of the present disclosure there is provided a computer readable medium having a computer program recorded thereon for selecting at least one user interface object, displayed on a display screen of a multi-touch device, from a plurality of user interface objects, said program comprising:

code for determining a plurality of user interface objects, each said object representing an image and being associated with metadata values;

code for displaying a set of the user interface objects on the display screen, one or more of said displayed user interface objects at least partially overlapping;

code for detecting a user pointer motion gesture on the multi-touch device in relation to the display screen, said user pointer motion gesture defining a magnitude value;

code for moving, in response to said motion gesture, one or more of the displayed user interface objects to reduce the overlap between the user interface objects in a first direction, wherein the movement of each user interface object is based on the magnitude value, the metadata values associated with that user interface object, and on at least one metadata attribute; and

code for selecting a subset of the displayed user interface objects which moved in response to the motion gesture.

According to still another aspect of the present disclosure there is provided a method of selecting at least one user interface object, displayed on a display screen associated with a gesture detection device from a plurality of user interface objects, said method comprising:

determining a plurality of user interface objects, each said object representing an image and being associated with metadata values;

displaying a set of the user interface objects on the display screen, one or more of said displayed user interface objects at least partially overlapping;

detecting a user pointer motion gesture on the gesture detection device in relation to the display screen, said user pointer motion gesture defining a magnitude value;

moving, in response to said motion gesture, one or more of the displayed user interface objects to reduce the overlap between the user interface objects in a first direction, wherein the movement of each user interface object is based on the magnitude value, the metadata values associated with that user interface object, and on at least one metadata attribute; and

selecting a subset of the displayed user interface objects which moved in response to the motion gesture.

Other aspects of the invention are also disclosed.

### BRIEF DESCRIPTION OF THE DRAWINGS

At least one embodiment of the present invention will now be described with reference to the following drawings, in which:

FIG. 1A shows a high-level system diagram of a user, an electronic device with a touch screen, and data sources relating to digital images, and;

FIGS. 1B and 1C collectively form a schematic block diagram representation of the electronic device upon which described arrangements may be practised;

FIG. 2 is a schematic flow diagram showing a method of selecting a user interface object, displayed on a display screen of a device, from a plurality of user interface objects;

FIG. 3A shows a screen layout comprising images displayed in a row according to one arrangement;

FIG. 3B shows a screen layout comprising images displayed in a pile according to another arrangement;

FIG. 3C shows a screen layout comprising images displayed in a grid according to another arrangement;

FIG. 3D shows a screen layout comprising images displayed in an album gallery according to another arrangement;

FIG. 3E shows a screen layout comprising images displayed in a stack according to another arrangement;

FIG. 3F shows a screen layout comprising images displayed in row or column according to another arrangement;

FIG. 4A show the movement of user interface objects on the display of FIG. 1A depending on a detected motion gesture, in accordance with one example;

FIG. 4B shows the movement of user interface objects on the display of FIG. 1A depending on a detected motion gesture, in accordance with another example;

FIG. 5A shows the movement of user interface objects on the display of FIG. 1A depending on a detected motion gesture, in accordance with another example;

FIG. 5B shows the movement of user interface objects on the display of FIG. 1A depending on a detected motion gesture, in accordance with another example;

FIG. 6A shows an example of a free-form selection gesture;

FIG. 6B shows an example of a bisection gesture.

FIG. 7A shows an example digital image; and

FIG. 7B shows metadata consisting of attributes and their attribute values, corresponding the digital image of FIG. 7A.

### DETAILED DESCRIPTION OF ARRANGEMENTS OF THE INVENTION

Where reference is made in any one or more of the accompanying drawings to steps and/or features, which have the same reference numerals, those steps and/or features have for the purposes of this description the same function(s) or operation(s), unless the contrary intention appears.

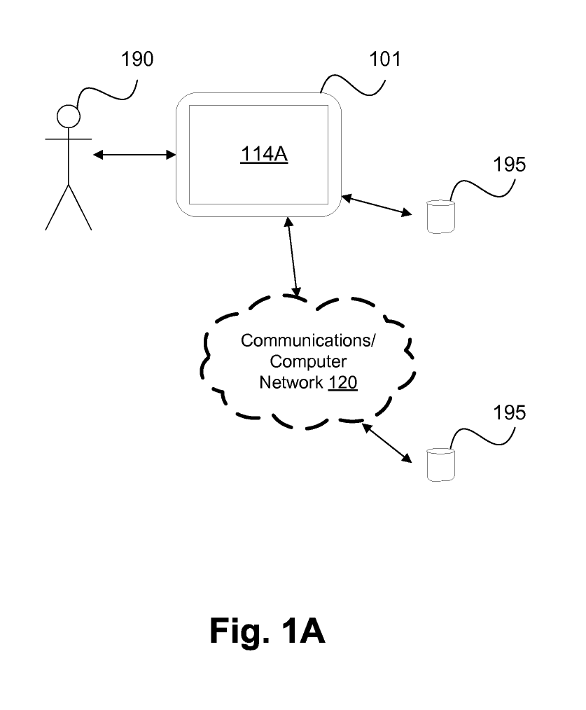

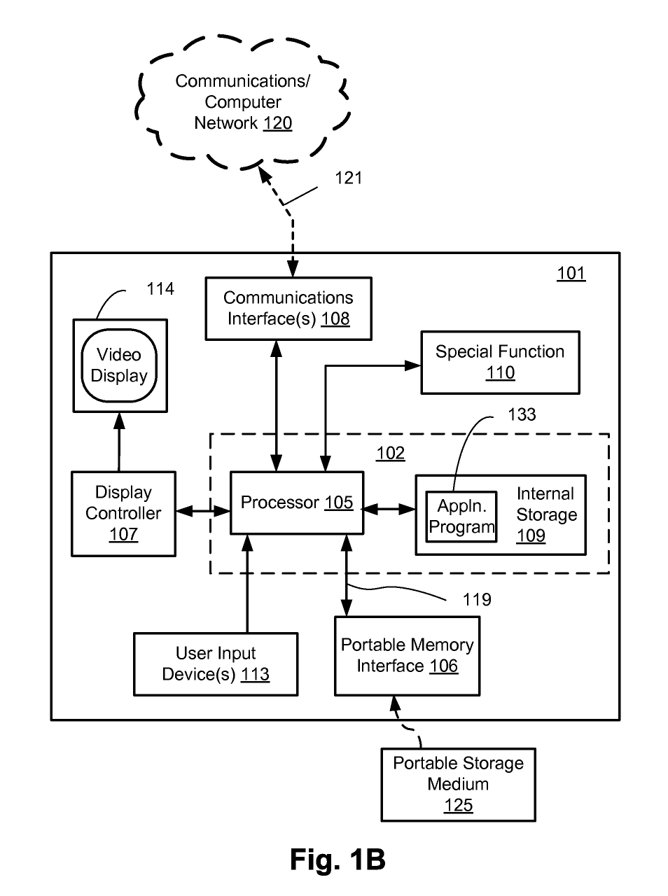

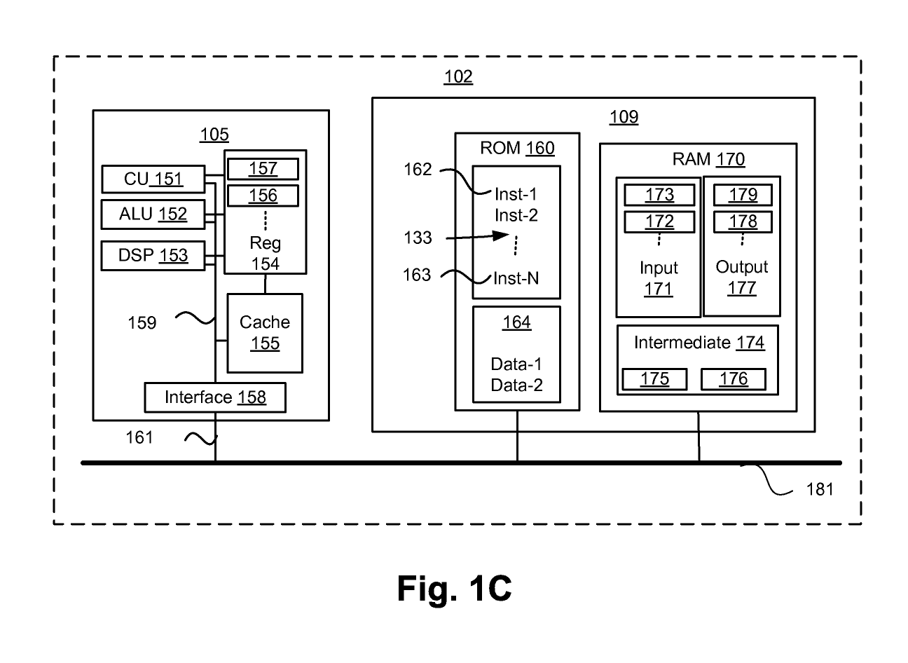

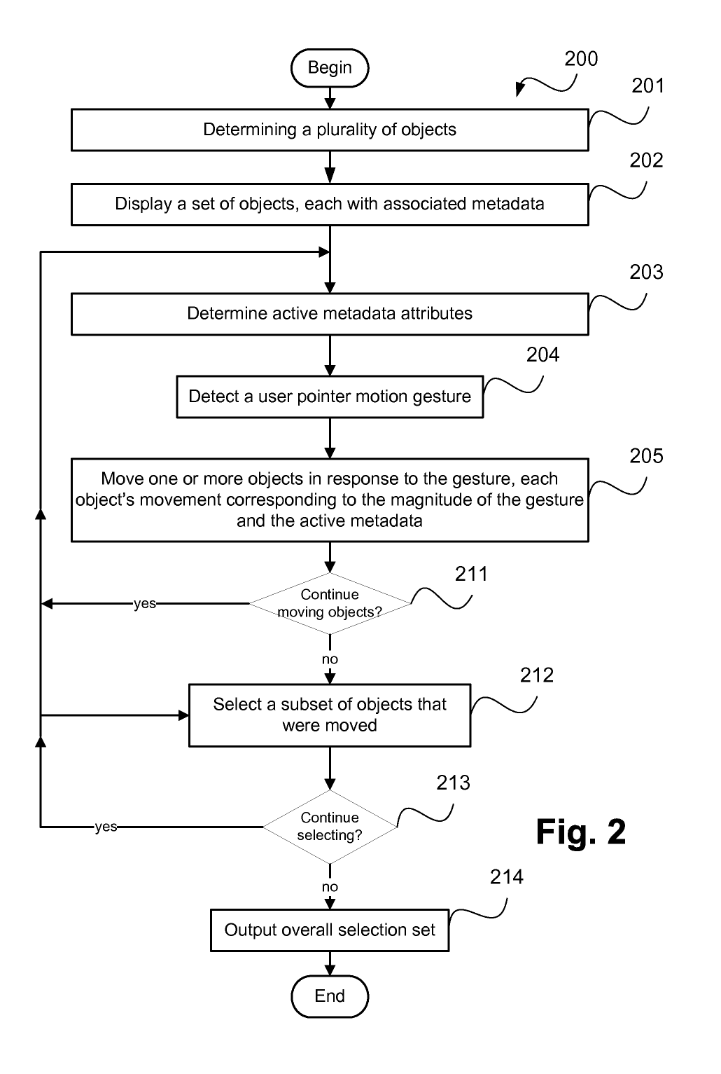

A method 200 (see FIG. 2) of selecting a user interface object, displayed on a display screen 114A (see FIG. 1A) of a device 101 (see FIGS. 1A, 1B and 1C), from a plurality of user interface objects, is described below. The method 200 may be used for digital image management tasks such as searching, browsing or selecting images from a collection of images. Images, in this context, refers to captured photographs, illustrative pictures or diagrams, documents, etc.

FIGS. 1A, 1B and 1C collectively form a schematic block diagram of a general purpose electronic device 101 including embedded components, upon which the methods to be described, including the method 200, are desirably practiced. The electronic device 101 may be, for example, a mobile phone, a portable media player or a digital camera, in which processing resources are limited. Nevertheless, the methods to be described may also be performed on higher-level devices such as desktop computers, server computers, and other such devices with significantly larger processing resources.

As seen in FIG. 1B, the electronic device 101 comprises an embedded controller 102. Accordingly, the electronic device 101 may be referred to as an “embedded device.” In the present example, the controller 102 has a processing unit (or processor) 105 which is bi-directionally coupled to an internal storage module 109. The storage module 109 may be formed from non-volatile semiconductor read only memory (ROM) 160 and semiconductor random access memory (RAM) 170, as seen in FIG. 1B. The RAM 170 may be volatile, non-volatile or a combination of volatile and non-volatile memory.

The electronic device 101 includes a display controller 107, which is connected to a video display 114, such as a liquid crystal display (LCD) panel or the like. The display controller 107 is configured for displaying graphical images on the video display 114 in accordance with instructions received from the embedded controller 102, to which the display controller 107 is connected.

The electronic device 101 also includes user input devices 113. The user input device 113 includes a touch sensitive panel physically associated with the display 114 to collectively form a touch-screen. The touch-screen 114A thus operates as one form of graphical user interface (GUI) as opposed to a prompt or menu driven GUI typically used with keypad-display combinations. In one arrangement, the device 101 including the touch-screen 114A is configured as a “multi-touch” device which recognises the presence of two or more points of contact with the surface of the touch-screen 114A.

The user input devices 113 may also include keys, a keypad or like controls. Other forms of user input devices may also be used, such as mouse, a keyboard, a microphone (not illustrated) for voice commands or a joystick/thumb wheel (not illustrated) for ease of navigation about menus.

As seen in FIG. 1B, the electronic device 101 also comprises a portable memory interface 106, which is coupled to the processor 105 via a connection 119. The portable memory interface 106 allows a complementary portable memory device 125 to be coupled to the electronic device 101 to act as a source or destination of data or to supplement the internal storage module 109. Examples of such interfaces permit coupling with portable memory devices such as Universal Serial Bus (USB) memory devices, Secure Digital (SD) cards, Personal Computer Memory Card International Association (PCMIA) cards, optical disks and magnetic disks.

The electronic device 101 also has a communications interface 108 to permit coupling of the device 101 to a computer or communications network 120 via a connection 121. The connection 121 may be wired or wireless. For example, the connection 121 may be radio frequency or optical. An example of a wired connection includes Ethernet. Further, an example of wireless connection includes Bluetooth™ type local interconnection, Wi-Fi (including protocols based on the standards of the IEEE 802.11 family), Infrared Data Association (IrDa) and the like.

Typically, the electronic device 101 is configured to perform some special function. The embedded controller 102, possibly in conjunction with further special function components 110, is provided to perform that special function. For example, where the device 101 is a digital camera, the components 110 may represent a lens, focus control and image sensor of the camera. The special function components 110 are connected to the embedded controller 102. As another example, the device 101 may be a mobile telephone handset. In this instance, the components 110 may represent those components required for communications in a cellular telephone environment. Where the device 101 is a portable device, the special function components 110 may represent a number of encoders and decoders of a type including Joint Photographic Experts Group (JPEG), (Moving Picture Experts Group) MPEG, MPEG-1 Audio Layer 3 (MP3), and the like.

The methods described hereinafter may be implemented using the embedded controller 102, where the processes of FIGS. 2 to 7 may be implemented as one or more software application programs 133 executable within the embedded controller 102. The electronic device 101 of FIG. 1B implements the described methods. In particular, with reference to FIG. 1C, the steps of the described methods are effected by instructions in the software 133 that are carried out within the controller 102. The software instructions may be formed as one or more code modules, each for performing one or more particular tasks. The software may also be divided into two separate parts, in which a first part and the corresponding code modules performs the described methods and a second part and the corresponding code modules manage a user interface between the first part and the user.

The software 133 of the embedded controller 102 is typically stored in the non-volatile ROM 160 of the internal storage module 109. The software 133 stored in the ROM 160 can be updated when required from a computer readable medium. The software 133 can be loaded into and executed by the processor 105. In some instances, the processor 105 may execute software instructions that are located in RAM 170. Software instructions may be loaded into the RAM 170 by the processor 105 initiating a copy of one or more code modules from ROM 160 into RAM 170. Alternatively, the software instructions of one or more code modules may be pre-installed in a non-volatile region of RAM 170 by a manufacturer. After one or more code modules have been located in RAM 170, the processor 105 may execute software instructions of the one or more code modules.

The application program 133 is typically pre-installed and stored in the ROM 160 by a manufacturer, prior to distribution of the electronic device 101. However, in some instances, the application programs 133 may be supplied to the user encoded on one or more CD-ROM (not shown) and read via the portable memory interface 106 of FIG. 1B prior to storage in the internal storage module 109 or in the portable memory 125. In another alternative, the software application program 133 may be read by the processor 105 from the network 120, or loaded into the controller 102 or the portable storage medium 125 from other computer readable media. Computer readable storage media refers to any non-transitory tangible storage medium that participates in providing instructions and/or data to the controller 102 for execution and/or processing. Examples of such storage media include floppy disks, magnetic tape, CD-ROM, a hard disk drive, a ROM or integrated circuit, USB memory, a magneto-optical disk, flash memory, or a computer readable card such as a PCMCIA card and the like, whether or not such devices are internal or external of the device 101. Examples of transitory or non-tangible computer readable transmission media that may also participate in the provision of software, application programs, instructions and/or data to the device 101 include radio or infra-red transmission channels as well as a network connection to another computer or networked device, and the Internet or Intranets including e-mail transmissions and information recorded on Websites and the like. A computer readable medium having such software or computer program recorded on it is a computer program product.

The second part of the application programs 133 and the corresponding code modules mentioned above may be executed to implement one or more graphical user interfaces (GUIs) to be rendered or otherwise represented upon the display 114 of FIG. 1B. Through manipulation of the user input device 113 (e.g., the touch-screen), a user of the device 101 and the application programs 133 may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers (not illustrated) and user voice commands input via the microphone (not illustrated).

FIG. 1C illustrates in detail the embedded controller 102 having the processor 105 for executing the application programs 133 and the internal storage 109. The internal storage 109 comprises read only memory (ROM) 160 and random access memory (RAM) 170. The processor 105 is able to execute the application programs 133 stored in one or both of the connected memories 160 and 170. When the electronic device 101 is initially powered up, a system program resident in the ROM 160 is executed. The application program 133 permanently stored in the ROM 160 is sometimes referred to as “firmware”. Execution of the firmware by the processor 105 may fulfil various functions, including processor management, memory management, device management, storage management and user interface.

The processor 105 typically includes a number of functional modules including a control unit (CU) 151, an arithmetic logic unit (ALU) 152 and a local or internal memory comprising a set of registers 154 which typically contain atomic data elements 156, 157, along with internal buffer or cache memory 155. One or more internal buses 159 interconnect these functional modules. The processor 105 typically also has one or more interfaces 158 for communicating with external devices via system bus 181, using a connection 161.

The application program 133 includes a sequence of instructions 162 though 163 that may include conditional branch and loop instructions. The program 133 may also include data, which is used in execution of the program 133. This data may be stored as part of the instruction or in a separate location 164 within the ROM 160 or RAM 170.

In general, the processor 105 is given a set of instructions, which are executed therein. This set of instructions may be organised into blocks, which perform specific tasks or handle specific events that occur in the electronic device 101. Typically, the application program 133 waits for events and subsequently executes the block of code associated with that event. Events may be triggered in response to input from a user, via the user input devices 113 of FIG. 1B, as detected by the processor 105. Events may also be triggered in response to other sensors and interfaces in the electronic device 101.

The execution of a set of the instructions may require numeric variables to be read and modified. Such numeric variables are stored in the RAM 170. The disclosed method uses input variables 171 that are stored in known locations 172, 173 in the memory 170. The input variables 171 are processed to produce output variables 177 that are stored in known locations 178, 179 in the memory 170. Intermediate variables 174 may be stored in additional memory locations in locations 175, 176 of the memory 170. Alternatively, some intermediate variables may only exist in the registers 154 of the processor 105.

The execution of a sequence of instructions is achieved in the processor 105 by repeated application of a fetch-execute cycle. The control unit 151 of the processor 105 maintains a register called the program counter, which contains the address in ROM 160 or RAM 170 of the next instruction to be executed. At the start of the fetch execute cycle, the contents of the memory address indexed by the program counter is loaded into the control unit 151. The instruction thus loaded controls the subsequent operation of the processor 105, causing for example, data to be loaded from ROM memory 160 into processor registers 154, the contents of a register to be arithmetically combined with the contents of another register, the contents of a register to be written to the location stored in another register and so on. At the end of the fetch execute cycle the program counter is updated to point to the next instruction in the system program code. Depending on the instruction just executed this may involve incrementing the address contained in the program counter or loading the program counter with a new address in order to achieve a branch operation.

Each step or sub-process in the processes of the methods described below is associated with one or more segments of the application program 133, and is performed by repeated execution of a fetch-execute cycle in the processor 105 or similar programmatic operation of other independent processor blocks in the electronic device 101.

As shown in FIG. 1A, a user 190 may use the device 101 implementing the method 200 to visually manipulate a set of image thumbnails in order to filter, separate and select images of interest. The user 190 may use finger gestures, for example, on the touch-screen 114A of the display 114 in order to manipulate the set of image thumbnails. The visual manipulation, which involves moving the thumbnails on the touch-screen 114A of the display 114, uses both properties of the gesture and image metadata to define the motion of the thumbnails.

Metadata is data describing other data. In digital photography, metadata may refer to various details about image content, such as which person or location is depicted. Metadata may also refer to image context, such as time of capture, event captured, what images are related, where the image has been exhibited, filename, encoding, color histogram, and so on.

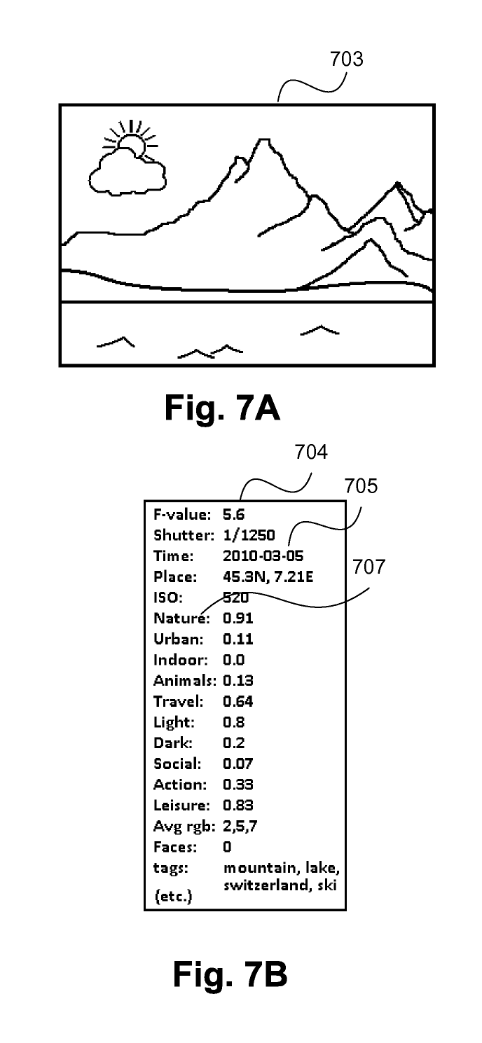

Image metadata may be stored digitally to accompany image pixel data. Well-known metadata formats include Extensible Image File Format (“EXIF”), IPTC Information Interchange Model (“IPTC header”) and Extensible Metadata Platform (“XMP”). FIG. 7B shows a simplified example of metadata 704 describing an example image 703 of a mountain and lake as seen in FIG. 7A. The metadata 704 takes the form of both metadata attributes and corresponding values. Values may be numerical (e.g., “5.6”), visual (e.g., an embedded thumbnail), oral (e.g., recorded sound), textual (“Switzerland”), and so on. The attributes may encompass many features, including: camera settings such as shutter speed and ISO; high-level visual features such as faces and landmarks; low-level visual features such as encoding, compression and color histogram; semantic or categorical properties such as “landscape”, “person”, “urban”; contextual features such as time, event and location; or user-defined features such as tags. In the example of FIG. 7B, the metadata 704 and associated values include the following:
(i) F-value: 5.6,
(ii) Shutter: 1/1250,
(iii) Time: 2010-03-05,
(iv) Place: 45.3N, 7.21E,
(v) ISO: 520,
(vi) Nature: 0.91,
(vii) Urban: 0.11,
(viii) Indoor: 0.0,
(ix) Animals: 0.13,
(x) Travel: 0.64,
(xi) Light: 0.8,
(xii) Dark: 0.2,
(xiii) Social: 0.07,
(xiv) Action: 0.33,
(xv) Leisure: 0.83,
(xvi) Avg rgb: 2, 5, 7,
(xvii) Faces: 0
(xviii) tags: mountain, lake, Switzerland, ski.

All of the above attributes constitute metadata for the image 703. The method 200 uses metadata like the above for the purposes of visual manipulation of the images displayed on the touch-screen 114A. The method 200 enables a user to use pointer gestures, such as a finger swipe, to move images that match particular metadata away from images that do not match the metadata. The method 200 allows relevant images to be separated and drawn into empty areas of the touch-screen 114A where the images may be easily noticed by the user. The movement of the objects in accordance with the method 200 reduces their overlap, thereby allowing the user 190 to see images more clearly and select only wanted images.

As described above, the touch-screen 114A of the device 101 enables simple finger gestures. However, the alternative user input devices 113, such as a mouse, keyboard, joystick, stylus or wrists may be used to perform gestures, in accordance with the method 200.

As seen in FIG. 1A, a collection of images 195 may be available to the device 101, either directly or via a network 120. For example, in one arrangement, the collection of images 195 may be stored within a server connected to the network 120. In another arrangement, the collection of images 195 may be stored within the storage module 109 or on the portable storage medium 125.

The images stored within the collection of image 195 have associated metadata 704, as described above. The metadata 704 may be predetermined. However, one or more metadata attributes may be analysed in real-time on the device 101 during execution of the method 200. The sample metadata attributes shown in FIG. 7B may include, for example, camera settings, file properties, geo-tags, scene categorisation, face recognition, and user keywords.

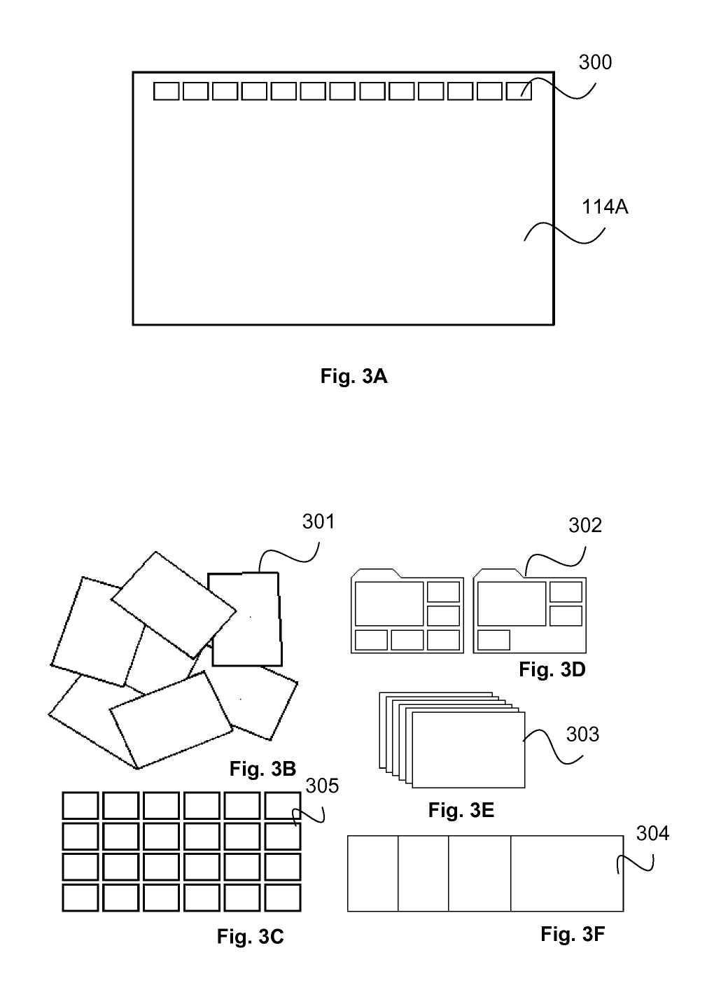

The method 200 of selecting a user interface object, displayed on the screen 114A, from a plurality of user interface objects, will now be described below with reference to FIG. 2. The method 200 may be implemented as one or more code modules of the software application program 133 executable within the embedded controller 102 and being controlled in their execution by the processor 105. The method 200 will be described by way of example with reference to FIGS. 3A to 6B.

The method 200 begins at determining step 201, where the processor 105 is used for determining a plurality of user interface objects, each object representing at least one image. In accordance with the present example, each of the user interface objects represents a single image from the collection of images 195, with each object being associated with metadata values corresponding to the represented image. The determined user interface objects may be stored within the RAM 170.

Then at displaying step 201, the processor 105 is used for displaying a set 300 of the determined user interface objects on the touch-screen 114A of the display 114. In one example, depending on the number of images being filtered by the user 190, one or more of the displayed user interface objects may be at least partially overlapping.

For efficiency reasons or interface limitations, only a subset of the set of user interface objects, representing a subset of the available images from the collection of images may be displayed on the screen 114A. In this instance, some of the available images from the collection of images 195 may be displayed off-screen or not included in the processing.

FIG. 3A shows an initial screen layout arrangement of user interface objects 300 representing displayed images. In the example of FIG. 3A, each of the user interface objects 300 may be a thumbnail image. In the initial screen layout arrangement of FIG. 3A, the objects 300 representing the images are arranged in a row. For illustrative purposes only a small number of objects representing images are shown in FIG. 3A. However, as described above, in practice the user 190 may be filtering through enough images that the user interface objects representing the images may substantially overlap and occlude when displayed on the screen 114A.

Alternatively, the user interface objects (e.g., thumbnail images) representing images may be displayed as a pile 301 (see FIG. 3B), an album gallery 302 (see FIG. 3D), a stack 303 (see FIG. 3E), a row or column 304 (see FIG. 3F) or a grid 305 (see FIG. 3C).

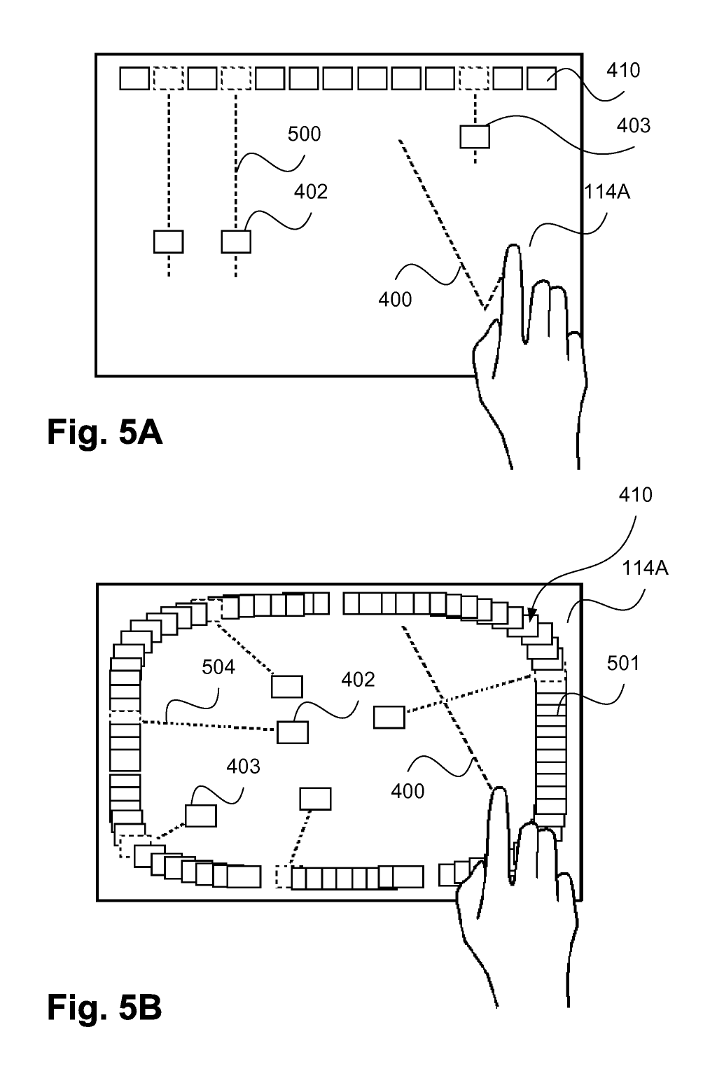

The method 200 may be used to visually separate and move images of user interest away from images not of interest. User interface objects representing images not being of interest may remain unmoved in their original position. Therefore, there are many other initial arrangements other than the arrangements shown in FIGS. 3A to 3F that achieve the same effect. For example, in one arrangement, the user interface objects 300 may be displayed as an ellipsoid 501, as shown in FIG. 5B.

In determining step 203 of the method 200, the processor 105 is used for determining active metadata to be used for subsequent manipulation of the images 300. The active metadata may be determined at step 202 based on suitable default metadata attributes and/or values. However, in one arrangement, metadata attributes and/or values of interest may be selected by the user 190. Details of the active metadata determined at step 203 may be stored within the RAM 170. Any set of available metadata attributes may be partitioned into active and inactive attributes. A suitable default may be to set only one attribute as active. For example, the image capture date may be a default active metadata attribute.

In one arrangement, the user may select which attributes are active. For instance, the goal of the user may be to find images of her family in leisurely settings. In this instance, the user may activate appropriate metadata attributes, such as a face recognition-based “people” attribute and a scene categorization-based “nature” attribute, indicating that the user is interested in images that have people and qualities of nature.

In detecting step 204, the processor 105 is used for detecting a user pointer motion gesture in relation to the display 114. For example, the user 190 may perform a motion gesture using a designated device pointer. On the touch-screen 114A of the device 101, the pointer may be the finger of the user 190. As described above, in one arrangement, the device 101, including the touch-screen 114A, is configured as a multi-touch device.

As the device 101, including the touch-screen 114A, is configured for detecting user pointer motion gestures, the device 101 may be referred to as a gesture detection device.

In one arrangement, the user pointer motion gesture detected at step 203 may define a magnitude value. In translation step 205, the processor 105 is used to analyse the motion gesture. The analysis may involve mathematical calculations using the properties of the gesture in relation to the screen 114A. For example, the properties of the gesture may include coordinates, trajectory, pressure, duration, displacement and the like. In response to the motion gesture, the processor 105 is used for moving one or more of the displayed user interface objects. The user interface objects moved at step 205 represent images that match the active metadata. For example, images that depict people and/or have a non-zero value for a “nature” metadata attribute 707 may be moved in response to the gesture. In contrast, images that do not have values for the active metadata attributes, or that have values that are below a minimal threshold, remain stationary. Accordingly, a user interface object is moved at step 205 based on the metadata values associated with that user interface object and at least one metadata attribute. In one example, the user interface objects may be moved at step 205 to reduce the overlap between the displayed user interface objects in a first direction.

The movement behaviour of each of the user interface objects (e.g., image thumbnails 300) at step 205 is at least partially based on the magnitude value defined by the gesture. In some arrangements, the direction of the gesture may also be used in step 205.

A user pointer motion gesture may define a magnitude in several ways. In one arrangement, on the touch-screen 114A of the device 101, the magnitude corresponds to the displacement of a gesture defined by a finger stroke. The displacement relates to the distance between start coordinates and end coordinates. For example, a long stroke gesture by the user 190 may define a larger magnitude than a short stroke gesture. Therefore, according to the method 200, a short stroke may cause highly-relevant images to move only a short distance. In another arrangement, the magnitude of the gesture corresponds to the length of the traced path (i.e., path length) corresponding to the gesture.

In yet a further arrangement, the magnitude of the gesture corresponds to duration of the gesture. For example, the user may hold down a finger on the touch-screen 114A, with a long hold defining a larger magnitude than a brief hold.

In yet a further arrangement relating to the device 101 configured as a multi-touch device, the magnitude defined by the gesture may correspond to the number of fingers, the distance between different contact points, or amount of pressure used by the user on the surface of the touch-screen 114A of the device 101.

In some arrangements, the movement of the displayed user interface objects, representing images, at step 205 is additionally scaled proportionately according to relevance of the image against the active metadata attributes. For example, an image with a high score for the “nature” attribute may move faster or more responsively than an image with a low value. In any arrangement, the magnitude values represented by motion gestures may be determined numerically. The movement behavior of the user interface objects representing images in step 205 closely relates to the magnitude of the gesture detected at step 204, such that user interface objects (e.g., thumbnail images 300) move in an intuitive and realistic manner.

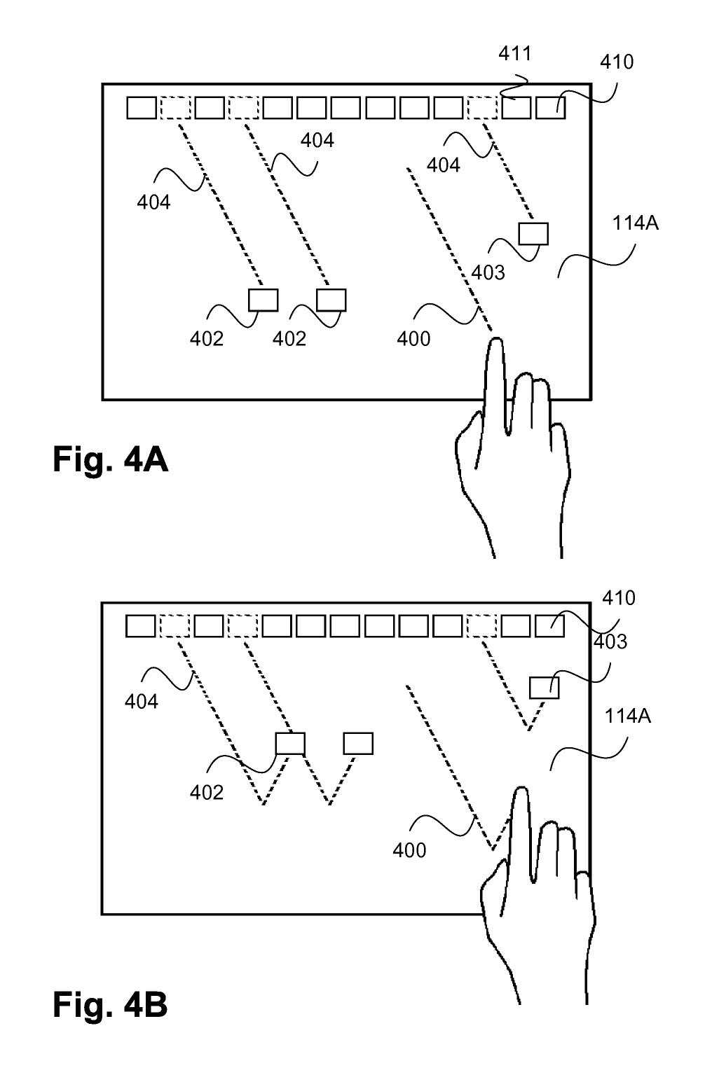

Steps 201 to 205 of the method 200 will now be further described with reference to FIGS. 4A, 4B, 5A and 5B. FIG. 4A shows an effect of a detected motion gesture 400 on a set of user interface objects 410 representing images. In the example of FIG. 4A, the user interface objects 410 are thumbnail images. As seen in FIG. 4A, user interface objects 402 and 403 representing images that match the active metadata attributes determined at step 203 are moved, while user interface objects (e.g., 411) representing non-matching images remain stationary. In the example of FIG. 4A, the user interface objects 402 and 403 move in the direction of the gesture 400. Additionally, the image 403 has moved a shorter distance compared to the images 402, since the image 403 is less relevant than the images 402 when compared to the active metadata determined at step 203. In this instance, the movement vector 404 associated with the user interface object 403 has been proportionately scaled. Accordingly, the distance moved by the moving objects 402 and 403 is scaled proportionately to relevance of the moving objects against at least one metadata attribute determined at step 203. Proportionality is not limited to linear scaling and may be quadratic, geometric, hyperbolic, logarithmic, sinusoidal or otherwise.

FIG. 4B shows another example where the gesture 400 follows a different path to the path followed by the gesture in FIG. 4A. In the example of FIG. 4B, the user interface objects 402 and 403 move in paths 404 that correspond to the direction of the gesture path 400 shown in FIG. 4B.

In another example, as shown in FIG. 5A, the movement behaviour of the user interface objects 410 at step 205 corresponds to the magnitude of the gesture 400 but not the direction of the gesture 400. In the example of FIG. 5A, the user interface objects 402 and 403 are moved in paths 500 parallel in a common direction that is independent of the direction of the gesture 400.

Similarly, FIG. 5B shows a screen layout arrangement where the user interface objects 410 are arranged as an ellipsoid 501. In the example of FIG. 5B, the movement paths (e.g., 504) of the user interface objects 410, at step 205, are independent of the direction of the gesture 400. However, the movement paths (e.g., 504) are dependent on the magnitude defined by the gesture 400. In the example of FIG. 5B, the user interface object 403 representing the less-relevant image 403 is moved a shorter distance compared to the user interface object 402 representing the more-relevant image, based on the image metadata associated with the images represented by the objects 402 and 403.

Returning to the method 200 of FIG. 2, after moving some of the user interface objects (e.g., 402,403) representing the images, in response to the motion gesture (e.g., gesture 400) detected at step 204, the method 200 proceeds to decision step 211.

In step 211, the processor 205 is used to determine if the displayed user interface objects are still being moved. If the displayed user interface objects are still being moved, then the method 200 returns to step 203. For example, at step 211, the processor 205 may detect that the user 190 has ceased a motion gesture and begun another motion gesture, thus moving the user interface objects in a different manner. In this instance, the method 200 returns to step 203.

In the instance that the method 200 returns to step 203, new metadata attributes and/or values to be activated may optionally be selected at step 203. For example, the user 190 may select new metadata attributes and/or values to be activated, using the input devices 113. The selection of new metadata attributes and/or values will thereby change which images respond to a next motion gesture detected at a next iteration of step 204. Allowing the new metadata attributes and/or values to be selected in this manner allows the user 190 to perform complex filtering strategies. Such filtering strategies may include, for example, moving a set of interface objects in one direction and then, by changing the active metadata, moving a subset of those same objects back in the opposite direction while leaving some initially-moved objects stationary. If another motion gesture is not detected at step 211 (e.g., the user 190 does not begin another motion gesture), then the method 200 proceeds to step 212.

At step 212, the processor 105 is used for selecting a subset of the displayed user interface objects (i.e., representing images) which were moved at step 205 in response to the motion gesture detected at step 204. In one arrangement, the user 190 may select one or more of the user interface objects representing images moved at step 205. Step 212 will be described in detail below with reference to FIG. 2. Details of the subset of user interface objects may be stored in the RAM 170. After selecting one or more of the displayed user interface objects and corresponding images at step 212, the method 200 proceeds to step 213.

At step 213, the processor 105 is used to determine if further selections of images are initiated. If further image selections are initiated, then the method 200 may return to step to step 212 where the processor 105 may be used for selecting a further subset of the displayed user interface objects. Alternatively, if further image movements are initiated at step 213, then the method 200 returns to step 203 where further motion gestures (e.g., 400) may be performed by the user 190 and be detected at step 204.

In one arrangement, the same user pointer motion gesture detected at a first iteration of the method 200 may be reapplied to the user interface objects (e.g., 410) displayed on the screen 114A again at a second iteration of step 205. Accordingly, the user pointer motion gesture may be reapplied multiple times.

If no further image selections or movements are initiated at step 213, then the method 200 proceeds to step 214.

At output step 214, the processor 105 is used to output the images selected during the method 200. For example, image files corresponding to the selected images may be stored within the RAM 170 and selected images may be displayed on the display screen 114A.

The images selected in accordance with the method 200 may be used by the user 190 for a subsequent task. For example, the selected images may be used for emailing a relative, uploading to a website, transferring to another device or location, copying images, making a new album, editing, applying tags, applying ratings, changing the device background, or performing a batch operation such as applying artistic filters and photo resizing to the selected images.

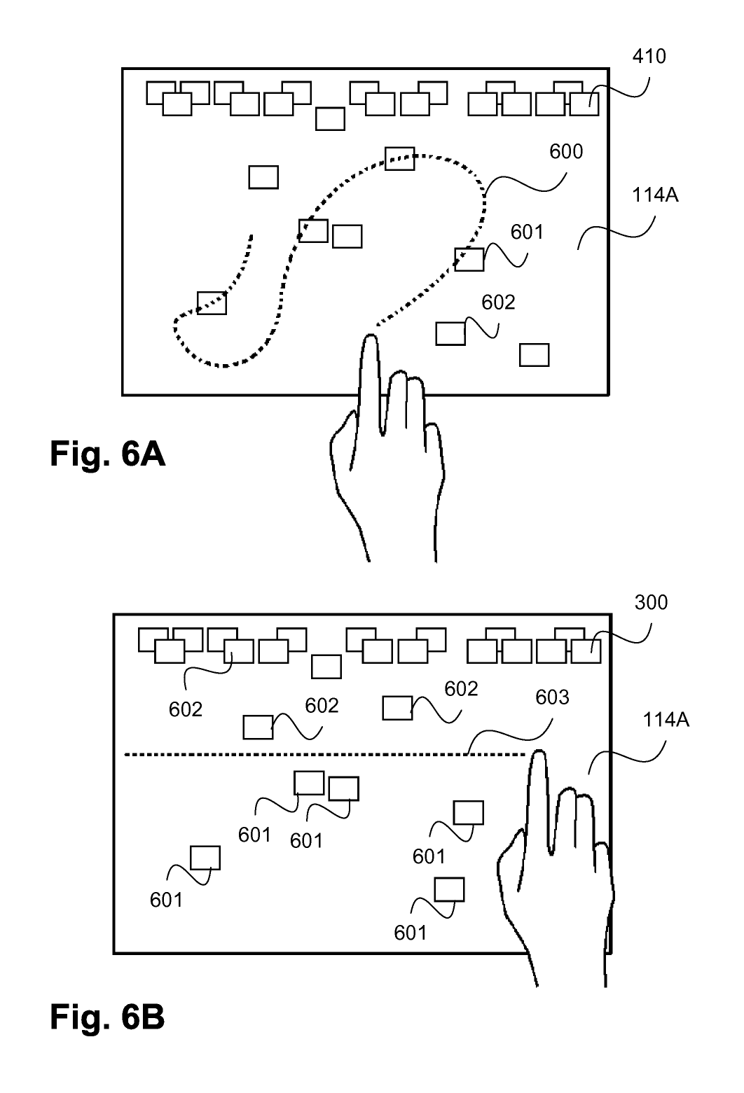

At selection step 212, the processor 105 may be used for selecting the displayed user interface objects (e.g., 402, 403) based on a pointer gesture, referred to below as a selection gesture 600 as seen in FIG. 6A. The selection gesture 600 may be performed by the user 190 for selecting a subset of the displayed user interface objects (i.e., representing images) which were moved at step 205. In one arrangement, the processor 105 may detect the selection gesture 600 in the form of a geometric shape drawn on the touch-screen 114A. In this instance, objects intersecting the geometric shape are selected using the processor 105 at step 212.

In one arrangement, the selection gesture 600 may be a free-form gesture as shown in FIG. 6A, where the user 190 traces an arbitrary path to define the gesture 600. In this instance, user interface objects that are close (e.g., 601) to the path traced by the gesture 600 may be selected while user interface objects (e.g., 602, 300) distant from the path traced by the gesture 600 are not selected. In one arrangement, the method 200 may comprise a step of visually altering a group of substantially overlapping user interface objects, said group being close to the path (i.e., traced by the gesture 600), such that problems caused by the overlapping and occlusion of the objects is mitigated and the user obtains finer selection control. In one arrangement, the method 200 may further comprise the step of flagging one or more substantially overlapping objects close to the path (i.e., traced by the gesture 600) as potential false-positives due to the overlap of the objects.

In another example, as shown in FIG. 6B, a selection gesture 603 that bisects the screen 114A into two areas (or regions) may be used to select a subset of the displayed user interface objects (i.e., representing images), which were moved at step 205. In the example of FIG. 6B, at step 212 of the method 200, the user interface objects 601 representing images on one side of the gesture 603 (i.e., falling in one region of the screen 114A) are selected and user interface objects 602 representing images on the other side of the gesture 603 (i.e., falling in another region of the screen 114A) are not selected.

In further arrangements, the method 200 may be configured so that user interface objects (i.e., representing images) are automatically selected if user interface objects are moved at step 205 beyond a designated boundary of the display screen 114A. In particular, in some arrangements, the most-relevant images (relative to the active metadata determined at step 203) will be most responsive to a motion gesture 400 and move the fastest during step 205, thereby reaching a screen boundary before the less-relevant images reach the screen boundary.

In yet further arrangements, the method 200 may be configured such that a region of the screen 114A is designated as an auto-select zone, such that images represented by user interface objects moved into the designated region of the screen are selected using the processor 105 without the need to perform a selection gesture (e.g., 600).

In some arrangements, after images are selected at step 212, the method 200 may perform additional visual rearrangements without user input. For example, if the user 190 selects a large number of displayed user interface objects representing images, the method 200 may comprise a step of uncluttering the screen 114A by removing unselected objects from the screen 114A and rearranging selected ones of the objects to consume the freed up space on the screen 114A. The performance of such additional visual rearrangements allows a user to refine a selection by focusing subsequent motion gestures (e.g., 400) and selection gestures (e.g., 600) on fewer images. Alternatively, after some images are selected in step 212, the user 190 may decide to continue using the method 200 and add images to a subset selected at step 212.

In some arrangements, the method 200, after step 212, may comprise an additional step of removing the selected objects from the screen 114A and rearranging unselected ones of the objects, thus allowing the user to “start over” and add to the initial selection with a second selection from a smaller set of images. In such arrangements, selected images that are removed from the screen remain marked as selected (e.g., in RAM 170) until the selected images are output at step 214.

The above described methods ennoble and empower the user 190 by allowing the user 190 to use very fast, efficient and intuitive pointer gestures to perform otherwise complex search and filtering tasks that have conventionally been time-consuming and unintuitive.

### INDUSTRIAL APPLICABILITY

The arrangements described are applicable to the computer and data processing industries and particularly for the image processing.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A method of selecting at least one user interface object, displayed on a display screen of a multi-touch device, from a plurality of user interface objects, said method comprising:
determining a plurality of user interface objects, each said object representing an image and being associated with metadata values;
displaying a set of the user interface objects on the display screen, one or more of said displayed user interface objects at least partially overlapping;
detecting a user pointer motion gesture on the multi-touch device in relation to the display screen, said user pointer motion gesture defining a magnitude value;
moving, in response to said motion gesture, one or more of the displayed user interface objects to reduce the overlap between the user interface objects in a first direction, wherein the movement of each user interface object is based on the magnitude value, the metadata values associated with that user interface object, and on at least one metadata attribute; and
selecting a subset of the displayed user interface objects which moved in response to the motion gesture.

2. The method according to claim 1, wherein the magnitude value corresponds with path length of a gesture.

3. The method according to claim 1, wherein the magnitude value corresponds to at least one of displacement of a gesture and duration of a gesture.

4. The method according to claim 1, wherein the user interface objects move in the direction of the gesture.

5. The method according to claim 1, wherein the user interface objects move parallel in a common direction, independent of the direction of the gesture.

6. The method according to claim 1, wherein the distance moved by a moving object is scaled proportionately to relevance against at least one metadata attribute.

7. The method according claim 1, wherein the user pointer motion gesture is reapplied multiple times.

8. The method according to claim 7, wherein the at least one metadata attribute is modified between two reapplied gestures such that a first of the two gestures moves one set of user interface elements in one direction while a second gesture, after modifying the at least one metadata attribute, moves a different set of elements in a different direction, such that some user interface elements are moved by both the first and second gestures.

9. The method according to claim 1, further comprising selecting the user interface objects based on a selection gesture.

10. The method according to claim 1, further comprising selecting the user interface objects based on a selection gesture, wherein the selection gesture defines a geometric shape such that user interface objects intersecting the shape are selected.

11. The method according to claim 1, further comprising selecting the user interface objects based on a selection gesture, wherein the selection gesture traces a path on the screen such that user interface objects close to the traced path are selected.

12. The method according to claim 1, further comprising selecting the user interface objects based on a selection gesture, wherein the selection gesture traces a path on the screen such that user interface objects close to the traced path are selected and a plurality of overlapping user interface objects close to the path are visually altered.

13. The method according to claim 1, further comprising selecting the user interface objects based on a selection gesture, wherein the selection gesture traces a path on the screen such that user interface objects close to the traced path are selected and overlapping objects close to the path are flagged as potential false-positives.

14. The method according to claim 1, further comprising selecting the user interface objects based on a selection gesture, wherein the selection gesture bisects the screen into two regions such that user interface objects in one of the two regions are selected.

15. The method according to claim 1, wherein the user interface objects are automatically selected if moved beyond a designated boundary of the screen.

16. The method according to claim 1, wherein the user interface objects moved to a designated region of the screen are selected.

17. The method according to claim 1, further comprising at least one of moving unselected ones of the user interface objects to original positions and removing unselected ones of the user interface objects from the screen.

18. The method according to claim 1, further comprising automatically rearranging selected ones of the user interface objects displayed on the screen.

19. An apparatus for selecting at least one user interface object, displayed on a display screen of a multi-touch device, from a plurality of user interface objects, said apparatus comprising:
means for determining a plurality of user interface objects, each said object representing an image and being associated with metadata values;
means for displaying a set of the user interface objects on the display screen, one or more of said displayed user interface objects at least partially overlapping;
means for detecting a user pointer motion gesture on the multi-touch device in relation to the display screen, said user pointer motion gesture defining a magnitude value;
means for moving, in response to said motion gesture, one or more of the displayed user interface objects to reduce the overlap between the user interface objects in a first direction, wherein the movement of each user interface object is based on the magnitude value, the metadata values associated with that user interface object, and on at least one metadata attribute; and
means for selecting a subset of the displayed user interface objects which moved in response to the motion gesture.

20. A system for selecting at least one user interface object, displayed on a display screen of a multi-touch device, from a plurality of user interface objects, said system comprising:
a memory for storing data and a computer program;
a processor coupled to said memory for executing said computer program, said computer program comprising instructions for:
determining a plurality of user interface objects, each said object representing an image and being associated with metadata values;
displaying a set of the user interface objects on the display screen, one or more of said displayed user interface objects at least partially overlapping;
detecting a user pointer motion gesture on the multi-touch device in relation to the display screen, said user pointer motion gesture defining a magnitude value;
moving, in response to said motion gesture, one or more of the displayed user interface objects to reduce the overlap between the user interface objects in a first direction, wherein the movement of each user interface object is based on the magnitude value, the metadata values associated with that user interface object, and on at least one metadata attribute; and
selecting a subset of the displayed user interface objects which moved in response to the motion gesture.

21. A computer readable medium having a computer program recorded thereon for selecting at least one user interface object, displayed on a display screen of a multi-touch device, from a plurality of user interface objects, said program comprising:
code for determining a plurality of user interface objects, each said object representing an image and being associated with metadata values;
code for displaying a set of the user interface objects on the display screen, one or more of said displayed user interface objects at least partially overlapping;
code for detecting a user pointer motion gesture on the multi-touch device in relation to the display screen, said user pointer motion gesture defining a magnitude value;
code for moving, in response to said motion gesture, one or more of the displayed user interface objects to reduce the overlap between the user interface objects in a first direction, wherein the movement of each user interface object is based on the magnitude value, the metadata values associated with that user interface object, and on at least one metadata attribute; and
code for selecting a subset of the displayed user interface objects which moved in response to the motion gesture.

22. A method of selecting at least one user interface object, displayed on a display screen associated with a gesture detection device from a plurality of user interface objects, said method comprising:
determining a plurality of user interface objects, each said object representing an image and being associated with metadata values;
displaying a set of the user interface objects on the display screen, one or more of said displayed user interface objects at least partially overlapping;
detecting a user pointer motion gesture on the gesture detection device in relation to the display screen, said user pointer motion gesture defining a magnitude value;
moving, in response to said motion gesture, one or more of the displayed user interface objects to reduce the overlap between the user interface objects in a first direction, wherein the movement of each user interface object is based on the magnitude value, the metadata values associated with that user interface object, and on at least one metadata attribute; and
selecting a subset of the displayed user interface objects which moved in response to the motion gesture.

23. A method of selecting at least one user interface object, displayed on a display screen of a multi-touch device, from a plurality of user interface objects, said method being substantially as herein before described with reference to any one of the embodiments as that embodiment is shown in the accompanying drawings.
